(19) United States
(12) Patent Application Publication
(10) Pub. No.: US 2016/0132924 A1
(43) Pub. Date: May 12, 2016

(54) METHODS AND SYSTEMS FOR CREATING EVENT-TRIGGERED MARKETING CAMPAIGNS

(71) Applicant: XEROX CORPORATION, Norwalk, CT (US)

(72) Inventors: VEERASUNDARAVEL THIRUGNANASUNDARAM, Webster, NY (US); Saravanan Krishnan, Indian Bank Colony (IN); Tong Sun, Penfield, NY (US); Arun Bakthavachalu, Webster, NY (US)

(21) Appl. No.: 14/538,214

(22) Filed: Nov. 11, 2014

(51) Int. Cl. G06Q 30/02; G06Q 50/00

(52) U.S. Cl. CPC G06Q 30/0252; G06Q 30/0261; G06Q 50/01

(57) ABSTRACT

The disclosed embodiments illustrate methods and systems for creating event-triggered marketing campaigns. The method includes determining one or more events by analyzing messages of one or more users on social media platforms. Each event has an associated location and a timeline. Thereafter, one or more first attributes, associated with a set of users, corresponding to each event, are determined from the one or more users. Further, one or more target customers are determined from one or more customers of an organization based on the one or more first attributes and one or more second attributes of the one or more customers. Thereafter, the marketing campaigns are created for the one or more target customers based on the one or more second attributes and a historical data of the one or more target customers. Further, media delivery channels for the marketing campaigns are determined based on the timeline of each event.

### TECHNICAL FIELD

The presently disclosed embodiments are related, in general, to marketing products/services. More particularly, the presently disclosed embodiments are related to methods and systems for creating event-triggered marketing campaigns.

### BACKGROUND

With the advancement of communication technology and the penetration of internet, organizations are increasingly searching for opportunities to market their products and services innovatively through effective media delivery channels. For example, social media platforms such as Facebook™, LinkedIn™, Twitter™, and the like, have emerged as popular media delivery channels for various organizations to create a visibility of their upcoming products and brands. However, to target potential customers who are not associated with such social media platforms has been a non-trivial problem.

### SUMMARY

According to the embodiments illustrated herein, there is provided a system for creating event-triggered marketing campaigns. The system includes a natural language processor configured to analyze one or more messages posted by one or more users on one or more social media platforms to extract information pertaining to one or more events. The information comprises at least a location information and timeline information associated with said one or more events. The natural language processor is further configured to analyze user profile of a set of users, from one or more users, associated with said one or more events, to determine one or more first attributes associated with said set of users. The system further includes one or more micro-processors configured to determine one or more target customers from one or more customers associated with an organization based on a comparison of the one or more first attributes and one or more second attributes associated with the one or more customers. The one or more micro-processors are further configured to create the marketing campaigns for the one or more target customers based at least on the one or more second attributes and a historical data associated with the one or more target customers. One or more media delivery channels are determined for the marketing campaigns based on the timeline associated with each of the one or more events. The system further includes a transceiver configured to send the marketing campaigns to the one or more target customers on the one or more media delivery channels.

According to the embodiments illustrated herein, there is provided a method for creating event-triggered marketing campaigns. The method includes determining, by a natural language processor, one or more events based on an analysis of one or more messages posted by one or more users on one or more social media platforms. Each of the one or more events has an associated location and an associated timeline. Thereafter, one or more first attributes, associated with a set of users, from the one or more users, are determined by the natural language processor. The one or more users correspond to each of the one or more events. Further, the method includes determining, by one or more micro-processors, one or more target customers from one or more customers of an organization based on a comparison of the one or more first attributes and one or more second attributes associated with the one or more customers. Further, the one or more micro-processors create the marketing campaigns for the one or more target customers based at least on the one or more second attributes and a historical data associated with the one or more target customers. One or more media delivery channels are determined for the marketing campaigns based on the timeline associated with each of the one or more events. The method further includes sending, by a transceiver, the marketing campaigns to the one or more target customers on the one or more media delivery channels.

According to the embodiments illustrated herein, there is provided a computer program product for use with a computing device. The computer program product comprises a non-transitory computer readable medium, the non-transitory computer readable medium stores a computer program code for creating event-triggered marketing campaigns. The computer readable program code is executable by one or more micro-processors in the computing device to determine, by a natural language processor, one or more events based on an analysis of one or more messages posted by one or more users on one or more social media platforms. Each of the one or more events has an associated location and an associated timeline. Thereafter, one or more first attributes, associated with a set of users, from the one or more users, are determined by the natural language processor. The one or more users correspond to each of the one or more events. The one or more micro-processors determine one or more target customers from one or more customers associated with an organization based on a comparison of the one or more first attributes and one or more second attributes associated with the one or more customers. Further, the one or more micro-processors create the marketing campaigns for the one or more target customers based at least on the one or more second attributes and a historical data associated with the one or more target customers. One or more media delivery channels are determined for the marketing campaigns based on the timeline associated with each of the one or more events. Thereafter, a transceiver sends the marketing campaigns to the one or more target customers on the one or more media delivery channels.

### BRIEF DESCRIPTION OF DRAWINGS

The accompanying drawings illustrate the various embodiments of systems, methods, and other aspects of the disclosure. Any person with ordinary skill in the art would appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram of a system environment in which various embodiments can be implemented;

FIG. 2 is a block diagram that illustrates a system for creating marketing campaigns, in accordance with at least one embodiment;

FIG. 3 is a message flow diagram illustrating flow of message/data between various components of the system environment, in accordance with at least one embodiment;

FIG. 4 is a flowchart illustrating a method for creating marketing campaigns, in accordance with at least one embodiment; and

FIG. 5 illustrates a flow diagram for creating marketing campaigns, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation, but that not every embodiment or example necessarily includes that particular feature, structure, characteristic, property, element, or limitation. Further, repeated use of the phrase “in an embodiment” does not necessarily refer to the same embodiment.

### DEFINITIONS

The following terms shall have, for the purposes of this application, the meanings set forth below.

A “user” refers to an individual who is a member of one or more social media platforms. In an embodiment, the user may have registered on a social media platform to become a member of the social media platform. During registration, the user may have provided various information such as, but not limited to, name, gender, location, age, education, profession, one or more images, interests/hobbies, and so forth. Such information may be used to create a user profile, containing various attributes, which may be maintained by the social media platform. In an embodiment, the user may perform one or more activities on the social media platform such as, but not limited to, posting a message on the social media platform, sharing other user's messages, and interacting with the other users of the social media platform.

A “social media platform” refers to a communication medium through which a user may interact with one or more other users who are known to or otherwise acquainted with the user. Further, apart from interacting with one another, the user and the one or more other users may post one or more messages on the social media platform. Thereafter, the one or more users may interact with one another in reference to the one or more messages. Examples of social media platforms include, but are not limited to, social networking websites (e.g., Facebook™, Twitter™, LinkedIn™, Google+™, and so forth), web-blogs, web-forums, community portals, online communities, or online interest groups.

A “message” refers to information communicated between two or more individuals or groups of individuals with respect to a particular topic. In an embodiment, one or more users of a social media platform may post one or more messages related to a topic of interest on the social media platform. The term “social media messages” is used hereinafter to refer to the one or more messages posted on the one or more social media platforms.

An “event” refers to an activity that occurs at a predetermined time at a predetermined location and involves one or more individuals. Further, an event may be related to a topic of interest. Examples of various types of events include, but are not limited to, a seasonal event, a personal event, a public event, a business event, or a sports event.

A “customer” refers to an individual/organization who/which purchases a product/service for self-use or for use by others. In an embodiment, an end user of a product/service may also correspond to a customer, even though the end user may or may not have purchased the product/service. In an embodiment, an end user may correspond to a direct/indirect user of the product/service.

A “target customer” refers to an individual/organization who/which is a potential customer of a product/service of an organization. In an embodiment, the target customer may be a user of product/service of a competitor organization. In an embodiment, one or more target customers may be identified from a set of customers of the organization for a particular marketing campaign.

An “organization” refers to an entity comprising a group of individuals engaged in a business of selling products/services to one or more other organizations or individuals.

“One or more first attributes” refer to characteristics of a set of users of a social media platform who have posted messages on the social media platform. In an embodiment, the messages may be of interest to an organization. Examples of the one or more first attributes may include, but are not limited to, an age, a gender, an educational qualification, an occupation, an income level, a marital status, a location of residence/work, or hobbies/interests.

“One or more second attributes” refer to characteristics of a set of customers/potential customers of an organization. In an embodiment, the organization may collect various types of data associated with the customers/potential customers, which the organization may store in a central repository (i.e., a database). Examples of the one or more second attributes may include, but are not limited to, an age, a gender, an educational qualification, an occupation, an income level, a marital status, a location of residence/work, or hobbies/interests.

“One or more overlay metrics” refer to a set of features abstracted from the one or more first attributes for comparison with the one or more second attributes to determine a set of relevant records from a customer database. In an embodiment, the set of relevant records are determined by overlaying the one or more overlay metrics over the one or more second attributes associated with the customers of the organization. In an embodiment, the set of relevant records may correspond to one or more target customers of the organization. In an embodiment, each overlay metric may correspond to a range of values associated with a corresponding first attribute from the one or more first attributes.

A “media delivery channel” refers to a physical or logical communication media on which a message may be multi-casted or broadcasted to one or more recipients. Examples of media delivery channels include, but are not limited to, a direct mailing channel, an email messaging channel, a Short Messaging Service (SMS) channel, a print media channel, a cell broadcasting channel, or a social media platform. In an embodiment, a media delivery channel may be utilized by an organization to deliver a marketing campaign to one or more target customers of the organization.

A “marketing campaign” refers to a set of initiatives undertaken by an organization to expand/consolidate its business by reaching out to its customers/potential customers with lucrative deals/offers.

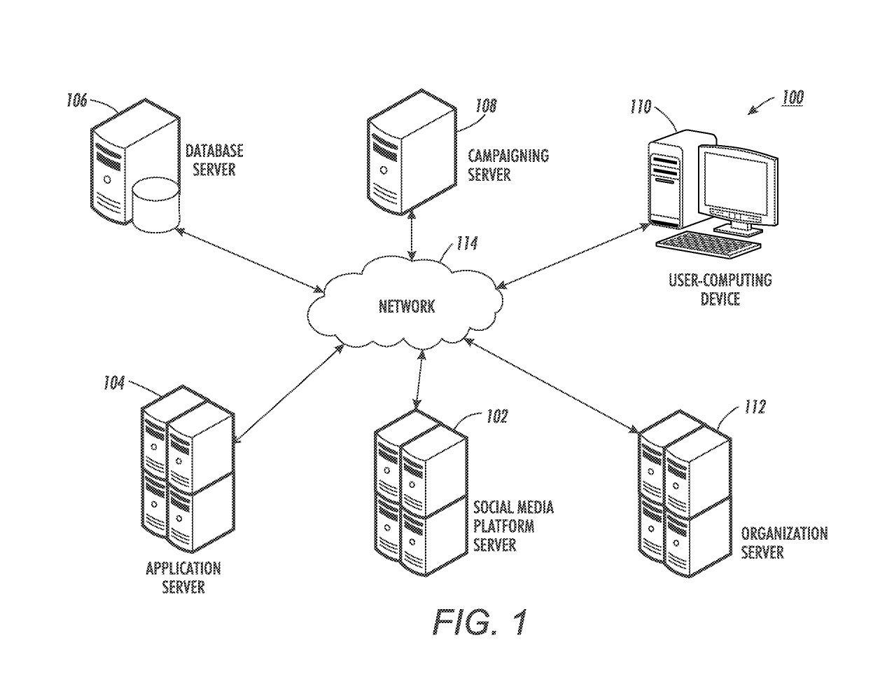

FIG. 1 is a block diagram of a system environment 100, in which various embodiments can be implemented. The system environment 100 includes a social media platform server 102, an application server 104, a database server 106, a campaigning server 108, a user-computing device 110, an organization server 112, and a network 114.

In an embodiment, the social media platform server 102 is configured to host the one or more social media platforms such as, but not limited to, a social networking website, a chat/messaging application, a web-blog, web-forums, a community portal, an online community, or an online interest group. In an embodiment, one or more users may register on the one or more social media platforms. In an embodiment, the one or more users may post one or more messages on the one or more social media platforms. In an embodiment, the social media platform server 102 may analyze the content of the one or more messages to determine a location, a topic, and a timeline associated with each message. In an embodiment, the one or more messages may be of interest to an organization. In an embodiment, the social media platform server 102 may store the one or more messages on the database server 106.

In an embodiment, the social media platform server 102 may be realized through various web-based technologies such as, but not limited to, a Java web-framework, a .NET framework, a PHP framework, or any other web-application framework.

In an embodiment, the application server 104 is configured to monitor the one or more messages to identify one or more events that may involve interaction among the one or more users of the social media platform. In an embodiment, each of the one or more events may have an associated location and an associated timeline. In an embodiment, the location associated with the one or more events may correspond to an area of business of an organization. In an embodiment, the one or more events may correspond to at least one of a seasonal event, a personal event, a public event, a business event, or a sports event. Further, in an embodiment, each event may be associated with one or more topics or trends. In an embodiment, the social media platform server 102 may analyze the one or more messages to determine a set of events associated with the analyzed messages. The application server 104 may query the social media platform server 102 for identifying the one or more events of interest to the organization from the set of events based on a location and/or a field/domain of work of the organization. Further, in an embodiment, the application server 104 may request to the social media platform server 102 for profile information associated with a set of users participating in the one or more events. In an embodiment, the set of user may further include users who have posted messages related to the one or more events, and thereby correspond to the one or more events. Thereafter, the application server 104 may determine one or more first attributes associated with the set of users based on the profile associated with the set of users.

Further, in an embodiment, the application server 104 may query the database server 106, storing information pertaining to one or more customers associated with an organization, to determine one or more target customers. In an embodiment, the one or more target customers may be determined based on a comparison of the one or more first attributes and one or more second attributes associated with the one or more customers. In an embodiment, each of the one or more first/second attributes may correspond to at least one of an age, a gender, an educational qualification, an occupation, an income level, a marital status, a location of residence/work, or hobbies/interests.

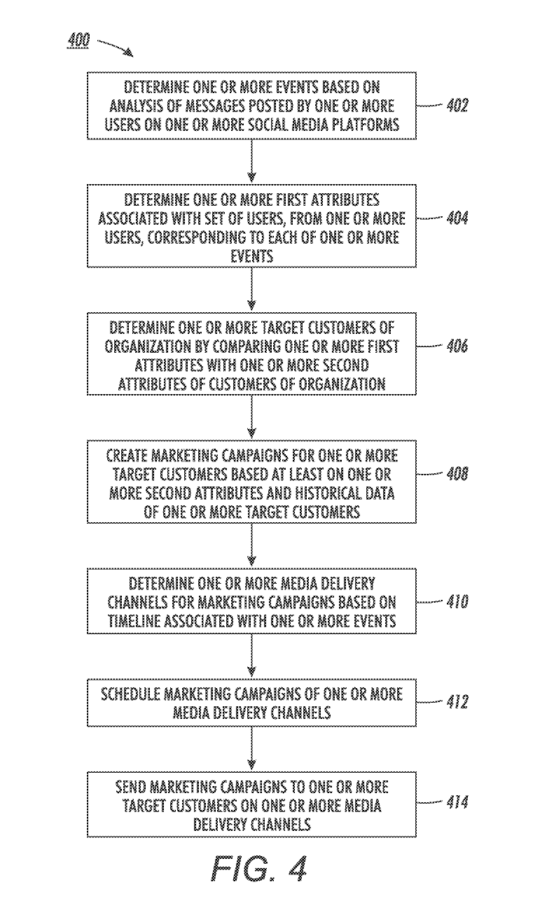

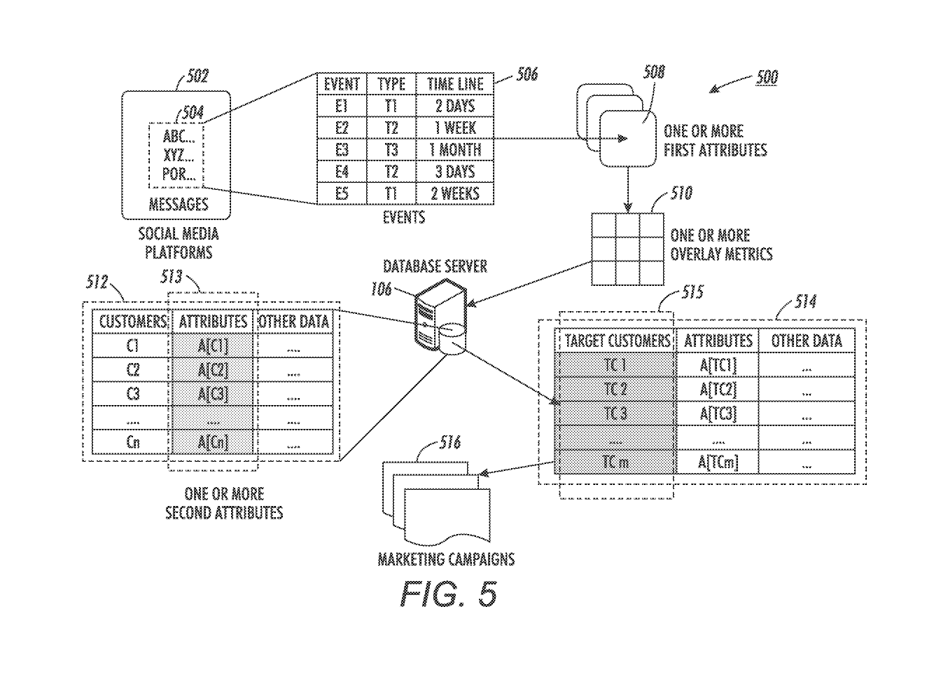

Further, in an embodiment, the application server 104 may create a marketing campaign for the one or more target customers based on the one or more second attributes and a historical data associated with the one or more target customers. In an embodiment, the historical data associated with the one or more target customers may be stored on the database server 106. The historical data may include purchase transaction details, brand/product preferences, and other details related to customer preferences. In an embodiment, the content within the marketing campaign so created may be based on such historical data. In an embodiment, the application server 104 may send information associated with the created marketing campaign to the campaigning server 108 and/or the social media platform server 102. In an embodiment, one or more media delivery channels may be determined for the marketing campaigns based on the timeline associated with each of the one or more events. Thereafter, the marketing campaigns may be scheduled on the one or more media delivery channels for the one or more target customers. In an embodiment, the one or more media delivery channels may correspond to at least one of a direct-mailing channel, an email-messaging channel, a Short Messaging Service (SMS) channel, a print-media channel, a cell broadcasting channel, or the one or more social media platforms. A method of creating the marketing campaign has been explained further in conjunction with FIG. 4. Further, a flow diagram for creation of the marketing campaign has been explained further in conjunction with FIG. 5.

In an embodiment, the application server 104 may be realized through various web-based technologies such as, but not limited to, a Java web-framework, a .NET framework, a PHP framework, or any other web-application framework.

In an embodiment, the database server 106 is configured to store details of the one or more customers such as, but not limited to, historical data associated with the customers and one or more second attributes associated with the customers. In an embodiment, the historical data of a customer may include information such as the customer's purchase transaction details, the customer's brand/product preferences, and so forth. In addition, in an embodiment, the database server 106 may store information associated with the one or more events, when the one or more events are determined. Further, in an embodiment, the database server 106 may store a mapping table corresponding to the media delivery channels. In an embodiment, decisions such as, but not limited to, “Which media delivery channel is to be used for which type of event?”, “Which channel partner/marketing agency is to be contacted for which type of marketing campaign/target customer?” and so on, may be taken based on the mapping table. In an embodiment, the mapping table may be defined by the organization and/or a marketing agency. In an embodiment, the database server 106 may be queried by at least one of the social media platform server 102, the application server 104, the campaigning server 108, or the organization server 112 to extract/store various information such as, but not limited to, the historical data associated with the customers, the one or more second attributes associated with the customers, the information associated with the one or more events, and the mapping table corresponding to the media delivery channels.

In an embodiment, the database server 106 may be realized through various technologies such as, but not limited to, Microsoft® SQL Server, Oracle™, and My SQL™. In an embodiment, the social media platform server 102, the application server 104, the campaigning server 108, or the organization server 112 may connect to the database server 106 using one or more protocols such as, but not limited to, Open Database Connectivity (ODBC) protocol and Java Database Connectivity (JDBC) protocol.

A person with ordinary skill in the art would understand that the scope of the disclosure is not limited to the database server 106 as a separate entity. In an embodiment, the functionalities of the database server 106 can be integrated into the application server 104 and/or the organization server 112.

In an embodiment, the campaigning server 108 may correspond to an application server/computing device of a marketing agency/channel partner. In an embodiment, the marketing agency/channel partner may have an association with the organization. For example, the marketing agency may be a business unit/department of the organization such as a marketing/sales/advertising department. Alternatively, the marketing agency may be a separate organization that has a contractual relationship with the organization for conducting the marketing campaign on behalf of the organization. In an embodiment, the campaigning server 108 may receive information pertaining to a scheduling of the marketing campaign for the one or more target customers on the one or more media delivery channels. In an embodiment, the campaigning server 108 may receive such information from the application server 104. In an alternate embodiment, the campaigning server 108 may query the mapping table stored on the database server 106 to retrieve such information. Based on the scheduling information and the media delivery channel selected for the marketing campaign, the campaigning server 108 may launch the marketing campaign for the target customers on the media delivery channel, so selected.

In an embodiment, the campaigning server 108 may be realized through various web-based technologies such as, but not limited to, a Java web-framework, a .NET framework, a PHP framework, or any other web-application framework. A person skilled in the art would appreciate that the scope of the disclosure is not limited to the campaigning server 108 being realized as an application server. The campaigning server 108 may be realized as an application hosted/running on a computing device such as, but not limited to, a personal computer, a laptop, a personal digital assistant (PDA), a mobile device, a tablet, or any other computing device.

A person with ordinary skill in the art would understand that the scope of the disclosure is not limited to realizing the campaigning server 108 as a separate entity. In an embodiment, the functionalities of the campaigning server 108 may be implemented/integrated on the application server 104 and/or the organization server 112.

In an embodiment, the user-computing device 110 may correspond to a computing device used by a user. In an embodiment, the user may be registered on at least one of the one or more social media platforms. Through a user-interface of the user-computing device 110, the user may post one or more messages on the one or more social media platforms, on which the user is registered. In an embodiment, the user may also correspond to a customer/potential customer of the organization. Further, the user may correspond to a target customer of the organization if the user is associated with at least one of the one or more events detected from the one or more messages, which are associated with the organization. In such a scenario, the user may receive content associated with the marketing campaign through the one or more media delivery channels selected for the distribution of such content to the user.

In an embodiment, the user-computing device 110 may be realized as one or more computing devices including, but not limited to, a personal computer, a laptop, a personal digital assistant (PDA), a mobile device, a tablet, or any other computing device.

A person skilled in the art would appreciate that one or more functionalities of the campaigning server 108 may be integrated with the social media platform server 102 and vice versa without departing from the scope of the disclosure.

In an embodiment, the organization server 112 may correspond to an application server/computing device of the organization. In an embodiment, one or more personnel/employees of the organization may use the organization server 112 to manage the marketing campaign. In an embodiment, the organization server 112 may be integrated with the application server 104, the database server 106, and/or the campaigning server 108.

In an embodiment, the organization server 112 may be realized through various web-based technologies such as, but not limited to, a Java web-framework, a .NET framework, a PHP framework, or any other web-application framework. A person skilled in the art would appreciate that the scope of the disclosure is not limited to the organization server 112 being realized as an application server. The organization server 112 may be realized as an application hosted/running on a computing device such as, but not limited to, a personal computer, a laptop, a personal digital assistant (PDA), a mobile device, a tablet, or any other computing device.

The network 114 corresponds to a medium through which content and messages flow between various devices of the system environment 100 (e.g., the social media platform server 102, the application server 104, the database server 106, the campaigning server 108, the user-computing device 110, and the organization server 112). Examples of the network 114 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

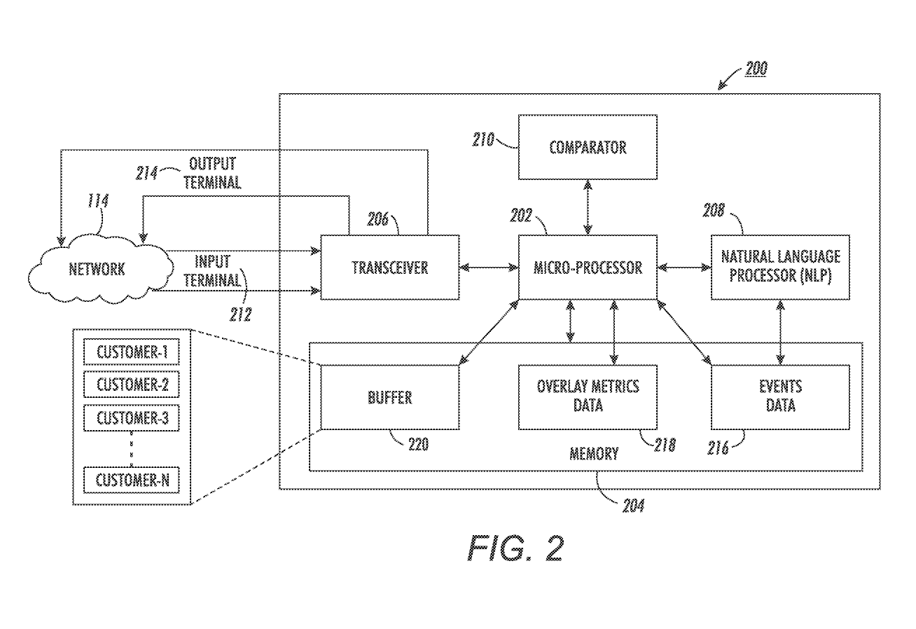

FIG. 2 is a block diagram that illustrates a system 200 for creating marketing campaigns, in accordance with at least one embodiment. In an embodiment, the system 200 may correspond to the social media platform server 102, the application server 104, the campaigning server 108, or the organization server 112. For the purpose of ongoing description, the system 200 is considered as the application server 104. However, the scope of the disclosure should not be limited to the system 200 as the application server 104. The system 200 can also be realized as the social media platform server 102, the campaigning server 108, or the organization server 112.

The system 200 includes a micro-processor 202, a memory 204, a transceiver 206, a Natural Language Processor (NLP) 208, and a comparator 210. The micro-processor 202 is coupled to the memory 204, the transceiver 206, the NLP 208, and the comparator 210. The transceiver 206 is connected to the network 114 through an input terminal 212 and an output terminal 214.

The micro-processor 202 includes suitable logic, circuitry, and/or interfaces that are operable to execute one or more instructions stored in the memory 204 to perform predetermined operations. The micro-processor 202 may be implemented using one or more processor technologies known in the art. Examples of the micro-processor 202 include, but are not limited to, an x86 processor, an ARM processor, a Reduced Instruction Set Computing (RISC) processor, an Application Specific Integrated Circuit (ASIC) processor, a Complex Instruction Set Computing (CISC) processor, or any other processor.

The memory 204 stores a set of instructions and data. In an embodiment, the memory 204 may include events data 216, overlay metrics data 218, and a buffer 220. In an embodiment, the buffer 220 may store a list of customers and their attributes. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the micro-processor 202 to perform specific operations. It is apparent to a person with ordinary skills in the art that the one or more instructions stored in the memory 204 enable the hardware of the system 200 to perform the predetermined operations.

The transceiver 206 transmits and receives messages and data to/from various components of the system environment 100 (e.g., the social media platform server 102, the database server 106, the campaigning server 108, the user-computing device 110, or the organization server 112) over the network 114. In an embodiment, the transceiver 206 is coupled to the input terminal 212 and the output terminal 214 through which the transceiver 206 may receive and transmit data/messages respectively. In an embodiment, the input terminal 212 and the output terminal 214 may be realized through, but are not limited to, an antenna, an Ethernet port, a USB port, or any other port that can be configured to receive and transmit data. The transceiver 206 transmits and receives data/messages in accordance with the various communication protocols, such as, TCP/IP, UDP, and 2G, 3G, or 4G communication protocols through the input terminal 212 and the output terminal 214.

The natural language processor (NLP) 208 is a micro-processor configured to analyze natural language content to draw meaningful conclusions therefrom. In an embodiment, the NLP 208 may employ one or more natural language processing and one or more machine learning techniques known in the art to perform the analysis of the natural language content. Examples of such techniques include, but are not limited to, Naïve Bayes classification, artificial neural networks, Support Vector Machines (SVM), multinomial logistic regression, or Gaussian Mixture Model (GMM) with Maximum Likelihood Estimation (MLE). Though the NLP 208 is depicted as separate from the micro-processor 202 in FIG. 2, a person skilled in the art would appreciate that the functionalities of the NLP 208 may be implemented within the micro-processor 202 without departing from the scope of the disclosure.

The comparator 210 is configured to compare at least two input signals to generate an output signal. In an embodiment, the output signal may correspond to either ‘1’ or ‘0’. In an embodiment, the comparator 210 may generate output ‘1’ if the value of a first signal (from the at least two signals) is greater than a value of the second signal (from the at least two signals). Similarly, the comparator 210 may generate an output ‘0’ if the value of the first signal is less than the value of the second signal. In an embodiment, the comparator 210 may be realized through either software technologies or hardware technologies known in the art. Though, the comparator 210 is depicted as independent from the micro-processor 202 in FIG. 2, a person skilled in the art would appreciate the comparator 210 may be implemented within the micro-processor 202 without departing from the scope of the disclosure.

The operation of the system 200 for creating the marketing campaigns has been described in conjunction with FIG. 4.

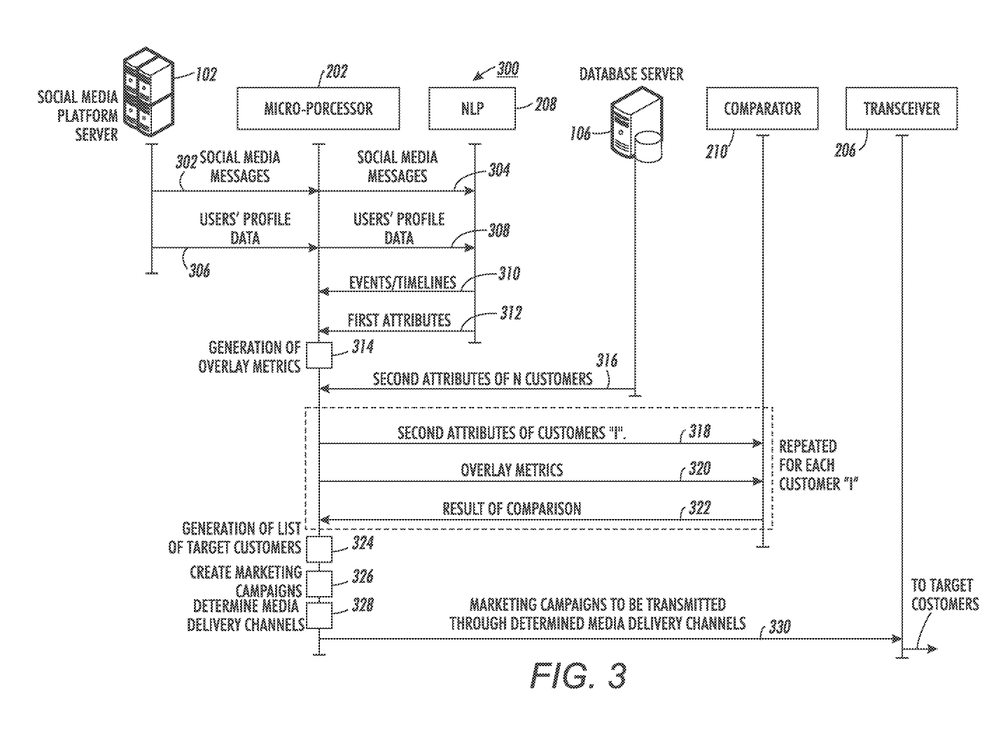

FIG. 3 is a message flow diagram 300 illustrating flow of message/data between various components of the system environment 100, in accordance with at least one embodiment.

As shown in FIG. 3, the micro-processor 202 may receive social media messages (i.e., the one or more messages posted on social media platforms) from the social media platform server 102 (depicted by 302). Further, the micro-processor 202 may pass the received social media messages to the NLP 208 for analysis (depicted by 304). The microprocessor 202 may also receive profile information of users associated with the social media messages (depicted by 306). The micro-processor 202 may send the profile information of such users to the NLP 208 for analysis (depicted by 308).

The NLP 208 may analyze the social media messages by utilizing one or more natural language processing techniques to determine events and timelines associated with the events, which the NLP 208 may send to the micro-processor 202 (depicted by 310). The information pertaining to the events and associated timelines is then stored on as events data 216 within the memory 204. Further, the NLP 208 may determine the set of users that are associated with the events and thereafter analyze the profile information associated with the set of users. Based on such analysis, the NLP 208 may determine one or more first attributes associated with set of users, which the NLP 208 may send to the micro-processor 202 (depicted by 312). Based on the one or more first attributes, the micro-processor 202 may generate one or more overlay metrics (depicted by 314). The one or more overlay metrics are then stored as overlay metrics data 218.

Thereafter, the micro-processor 202 may receive one or more second attributes of one or more customers of the organization from the database server 106 (depicted by 316). The one or more second attributes of each of the one or more customers are temporarily stored in the buffer 220 in the memory 204. Thereafter, the micro-processor 202 sends the one or more second attributes associated with the first customer (depicted by 318) and the one or more overlay metrics (depicted by 320) to the comparator 210. Based on a comparison of the one or more second attributes of the first customer and the one or more overlay metrics, the comparator 210 determines whether the first customer is a target customer or not. The comparator 210 sends the result of the comparison back to the micro-processor 202 (depicted by 322). Similarly, the micro-processor 202 sends the one or more second attributes of the second customer along with the one or more overlay metrics to the comparator 210 for comparison, and so on, for each of the one or more customers. The comparator 210 sends the results of each such comparison back to the micro-processor 202. The micro-processor 202 generates a list of target customers from the one or more customers (depicted by 324) based on the received results from the comparator 210. In an embodiment, the list of target customers may be stored on the buffer 220 in the memory 204. Though not shown in FIG. 3, the micro-processor 202 may send the list of target customers to the database server 106 for storage, instead of storing on the buffer 220.

In another embodiment, instead of sending the one or more overlay metrics to the comparator 210, the micro-processor 202 may send the one or more overlay metrics to the database server 106. The database server 106 may compare the one or more overlay metrics with the one or more second attributes of each of the one or more customers to determine the list of target customers. In an embodiment, the database server 106 may send the list of target customers back to the micro-processor 202. Alternatively, the database server 106 may flag the customers from the one or more customers stored on the database server 106, which are target customers.

Post generation of the list of target customers, the micro-processor 202 may create marketing campaigns (depicted by 326). The creation of the marketing campaigns has been explained further in step 408. Further, the micro-processor 202 determines media delivery channels on which the created marketing campaigns are to be sent to the one or more target customers (depicted by 328). The determination of the media delivery channels has been further explained in step 410. Thereafter, the micro-processor 202 sends information pertaining to the marketing campaigns to be transmitted through the determined media delivery channels to the transceiver 206 (depicted by 330). The transceiver 206 sends the marketing campaigns on the determined media delivery channels to the one or more target customers.

FIG. 4 is a flowchart 400 illustrating a method for creating the marketing campaigns, in accordance with at least one embodiment. The flowchart 400 is described in conjunction with FIG. 1 and FIG. 2.

At step 402, the one or more events are determined based on the analysis of the one or more messages posted on the one or more social media platforms. In an embodiment, the NLP 208 is configured to determine the one or more events. In an embodiment, the NLP 208 first analyzes a set of messages posted on the one or more social media platforms by a set of users within/or near a geographical area of interest. In an embodiment, the geographical area of interest may correspond to an area of business of the organization. In an embodiment, the NLP 208 may utilize one or more machine learning techniques or one or more natural language processing techniques to analyze the set of messages. Based on the analysis, in an embodiment, the NLP 208 may determine the one or more events that may be of interest to the organization. Further, the one or more users may correspond to users from the set of users who may have posted messages related to the one or more events. For example, the organization provides products/services related to a gaming industry. Further, the organization wishes to target users from India. In such a scenario, events of interest for the organization may include one or more events related to the gaming industry such as gaming conferences, gaming fests/competitions, etc., that are being organized within India. Such events of interest may be identified by analyzing one or more messages posted on one or more social media platforms. Further, one or more users from the set of users who posted the one or more messages related to gaming may be identified as participants in such events.

In an embodiment, the one or more events may be determined based on explicit or implicit content within the one or more messages that is related to the one or more events.

### Explicit Content Related to Events

For example, a user XYZ posts a status update on a social media site such as Facebook™, LinkedIn™, or Twitter™, that the user XYZ has checked-into a hotel ABC at a given location, say Rochester, N.Y., Further, the user XYZ may also add a tag-line to the status update, for instance, “A week-end get-away in NY”. Based on an analysis of such content posted by the XYZ, the event may be determined as “A vacation in NY”, with timeline as the “forthcoming week-end” and location as “the hotel ABC at Rochester, NY”. Thus, the explicit content related to the event along with supplementary information such as check-in based location and time may be used to determine the event.

### Implicit Content Related to Events

For example, a user-1 posts a status update on a social media site such as Facebook™, LinkedIn™, or Twitter™, that the user-1 wants to watch a game of rugby in his/her city on a forthcoming weekend. Further, the user-1 may tag one or more of his/her friends/acquaintances in the status post for their comments/availability for the game. If the user-1 is keen he/she may also send out an invite for the game through the social media site. Based on the analysis of the status update of the user-1, the event may be determined as “a Rugby Game” with a timeline as “the forthcoming weekend”. Though the user-1 may not specify the location of the event, but such information may be obtained from the user-1's profile. For example, if the user-1 lives in Rochester, N.Y., the location of the Rugby Game may also be predicted as “Rochester, NY”, i.e., the user-1's city. Further, based on analysis of status updates of other users in the area, the event may be clearly identified as a specific Rugby Game “ABC” at “Rochester, NY” on the forthcoming “Saturday”. Thus, implicit content related to the event may be inferred from the message to detect the event.

As is evident from the above examples, various events may be determined based on either on explicit check-ins, events, tags posted by the users (as for instance was in the case of the user ABC) or implicit comments and content within messages posted by the users and/or profile information of the users (as for instance was in the case of the user-1).

In an embodiment, the one or more events may be determined by the social media platform server 102. In an embodiment, the social media platform server 102 may receive a query to determine the one or more events that may be related to the organization. In an embodiment, the query may include information pertaining to the area/location of business of the organization and field/domain of work of the organization. In an embodiment, the organization server 112 or the application server 104 may send the query to the social media platform server 102 for the one or more events. Further, in an embodiment, the social media platform server 102 may periodically store information associated with the one or more events determined within a time interval on the database server 106. In an embodiment, the information associated with the one or more events may include meta-data related to the event such as an associated timeline, an associated location, and an associated topic. In an embodiment, the micro-processor 202 may retrieve the information pertaining to the one or more events detected during the time interval from the database server 106.

A person skilled in the art would appreciate that any known technique may be used to determine the one or more events from the one or more messages posted on the one or more social media sites, without departing from the scope of the disclosure. For example, various social media sites such as Facebook™, Twitter™, and Google+™, offer APIs for monitoring/listening to conversation of their users' at an abstract level. For instance, Twitter™ provides an API for monitoring trends, which correspond to frequently occurring keywords (commonly known as hashtags, e.g., #Rugby, #Sports, #NewYork, #RugbyinNY) within the conversations/posts of its registered users.

A person skilled in the art would appreciate that the one or more events may correspond to one or more products/services offered by the organization, one or more brands/marketing campaigns of the organization, or may be otherwise associated with the organization.

At step 404, the one or more first attributes associated with the one or more users, which correspond to the one or more events, are determined. In an embodiment, the NLP 208 is configured to determine the one or more first attributes associated with the one or more users from the set of users. In an embodiment, the one or more users correspond to the one or more detected events. Examples of the one or more first attributes include, but are not limited to, an age, a gender, an educational qualification, an occupation, an income level, a marital status, a location of residence/work, or hobbies/interests.

In an embodiment, the NLP 208 may determine the one or more first attributes by profiling the one or more users who posted messages related to the one or more events. In an embodiment, the profiling of the one or more users may be performed using one or more natural language processing (NLP) techniques and/or one or more machine learning techniques such as, but not limited to, Naïve Bayes classification, artificial neural networks, Support Vector Machines (SVM), multinomial logistic regression, or Gaussian Mixture Model (GMM) with Maximum Likelihood Estimation (MLE).

In an embodiment, the one or more first attributes may be determined based on information provided by the one or more users during a registration with the one or more social media platforms and/or while posting the one or more messages. In an embodiment, the one or more first attributes may be determined from the one or more messages. For instance, a user posts a message on a social media site announcing that he/she plans to visit a gallery showcasing paintings on modern/contemporary art in Rochester, N.Y. Thus, based on the content of the message, the first attributes “hobbies/interest” and “location of residence/work” may be predicted/determined as “interest in modern contemporary art” and “Rochester, NY”, respectively.

In an embodiment, one or more overlay metrics may be created from the one or more first attributes. In an embodiment, the each of the one or more overlay metrics may correspond to a range of values associated with a corresponding first attribute from the one or more first attributes. In an embodiment, depending on a type of the first attribute, the first attribute may be measurable on a scale such as, but not limited to, a nominal scale, an ordinal scale, an interval scale, or a ratio scale. In an embodiment, the range of the values of the first attribute may be determined based on the type of the first attribute, which in-turn may determine the scale on which the first attribute is measurable. For example, the first attribute “age” may be measured on a ratio scale, while the first attribute “gender” may be measured on a nominal scale. Similarly, the first attribute “income level” may be measured on a ratio scale, while the first attributes “educational qualification”, “occupation”, “marital status”, “location of residence/work”, and “hobbies/interests” may each be measured on a nominal scale. The following table illustrates an example of the range of values of the one or more first attributes.

TABLE 1
Example of range of values of the one or more first attributes

| One or more first | |
|---|---|
| attributes | Range of Values |
| Age | 11-15, 15-20, 20-25, 25-30, 30-40, 40-60, >60 |
| Gender | Male, Female |
| Educational | High School, Undergrad, Master's Degree, etc. |
| Qualification | |
| Occupation | Engineering, Medicine, Law, Education, Finance, etc. |
| Income Level | $20k-30k, $30k-40k, $40k-50k, $50k-60k, >$60k |
| (per annum) | |
| Marital Status | Single, Married, Widowed, Widower, Divorced |
| Location of | NY, CA, LA, MI, NC, Bay area, etc. |
| residence/work | |
| Hobbies/interests | Books, Games, Painting, Movies, etc. |

The above table illustrates an example the ranges of values of the one or more first attributes, which may be used to determine the one or more overlay metrics. Based on the analysis of the one or more events and the profile information associated with the one or more users who posted messages relevant to the one or more events, the micro-processor 202 may determine that the relevant ranges of values for the first attribute “age” as “15-20”, “20-25”, “25-30”, and “30-40”. Thereafter, the micro-processor 202 may determine the overlay metric corresponding to the first attribute “age” as the age group {15-40.} Similarly, if the micro-processor 202 determines that the one or more events are of interest to both Male and Female users, the micro-processor 202 may create the overlay metric corresponding to the first attribute “gender” as {“Male”, “Female”}. Further, if the event corresponds to a Rugby Game in Rochester, N.Y., the micro-processor 202 may determine that the first attributes “location of residence/work” and “hobbies/interests” as {“NY”} and {“Games”} respectively. Thus, in the current example, the micro-processor 202 may define the one or more overlay metrics as:

“{[age: {15-40}],

[gender: {“Male”, “Female”}],

[location of residence/work: {“NY”}],

[hobbies/interests: “{Games}”]}”.

The following table illustrates examples of the one or more overlay metrics that may be determined for various events:

TABLE 2
Example of one or more overlay metrics determined for one or more events

| Event | One or more overlay metrics |
|---|---|
| Home Improvement Sale | Age: 25-40 |
| | Gender: Female |
| | Occupation: Interior designer, housewife, etc. |
| | Hobbies/Interests: Home decorations, interior |
| | designing |
| Buffalo Wing Food Festival | Age: 20-45 |
| | Gender: Male, Female |
| | Location: Buffalo (NY), Niagara (NY), |
| | Rochester (NY) |
| | Hobbies/Interests: Food, Entertainment |
| Rochester Jazz Festival | Age: 35-55 |
| | Gender: Male, Female |
| | Location: Rochester, NY |
| | Hobbies/Interests: Music, Jazz, Cultural |
| | activities |

The above table illustrates an example of three events, namely, “Home Improvement Sale”, “Buffalo Wing Food Festival”, and “Rochester Jazz Festival”. As shown in the first row of Table 2, the individuals associated with the event “Home Improvement Sale” may include Females, primarily interior designers or housewives, belonging to the age group of 25-40, who are interested in home decoration and interior designing. Consequently, the one or more overlay metrics for the event “Home Improvement Sale” may be represented as:

“{[age: {25-40}],

[gender: {“Female”}],

[occupation: {“Interior Designer”, “Housewife”}],

[hobbies/interests: {“Home Decoration”, “Interior Designing”}]}”.

Similarly, the second row of table 2 illustrates the one or more overlay metrics corresponding to the event “Buffalo Wing Food Festival”, which may be represented as:

“{[age: {20-45}],

[gender: {“Male”, “Female”}],

[location: {“Buffalo, NY”, “Niagara, NY”, “Rochester, NY”}],

[hobbies/interests: {“Food”, “Entertainment”}]}”.

Further, the third row of table 2 illustrates the one or more overlay metrics corresponding to the event “Rochester Jazz Festival”, which may be represented as:

“{[age: {35-55}],

[gender: {“Male”, “Female”}],

[location: {“Rochester, NY”}],

[hobbies/interests: {“Music”, “Jazz”, “Cultural activities”}]}”.

At step 406, the one or more target customers of the organization are determined based on a comparison of the one or more first attributes, associated with the one or more users, and the one or more second attributes, associated with the one or more customers.

In an embodiment, the one or more customers may correspond to users of the products/services of the organization. The organization may identify the one or more customers from a customer database maintained on the database server 106. In an embodiment, the customer database may correspond to a repository of customers who have availed the products/services of the organization in the past. For example, a customer buys a graphics card of Nvidia® through an online shopping portal. The organization, Nvidia®, may maintain the customer's record with customer attributes such as location of the customer, product that he/she bought, age of the customer, etc., in the customer database. Alternatively, the customer may buy the graphics card from a retail store near his/her house. In such a scenario, the organization (Nvidia®) may obtain the customer's record from the retail store's database. A person having ordinary skill in the art would understand that there may exist an agreement between the retail store and the organization to share such data. In addition, the retail store database may include information of customers who buy products/services of competitor organizations. The organization may also obtain information associated with such customers from the retail store database.

In an embodiment, the comparator 210 (which is coupled to the micro-processor 202) is configured to determine the one or more target customers from the one or more customers for the organization to target, by comparing the one or more first attributes with the one or more second attributes. To that end, in an embodiment, the comparator 210 may utilize the one or more overlay metrics derived from the one or more first attributes (described in step 404). In an embodiment, the one or more second attributes may include, but are not limited to, an age, a gender, an educational qualification, an occupation, an income level, a marital status, a location of residence/work, or hobbies/interests. In an embodiment, the comparison may correspond to an overlaying of the one or more overlay metrics (derived from the one or more first attributes) over the one or more second attributes. In an embodiment, the comparator 210 may compare the one or more overlay metrics with the one or more second attributes to determine the one or more target customers. For instance, the one or more target customers related to “Buffalo Wing Food Festival” (refer Table 2) may be determined as those Male/Female customers who belong to the age group of 20 to 45, reside or work in or around Buffalo (NY), Niagara (NY), or Rochester (NY), and are foodies and/or entertainment buffs.

In another embodiment, the micro-processor 202 may utilize the one or more overlaying metrics as a database query to extract a list of the one or more target customers. The micro-processor 202 may send such database query (that includes the one or more overlay metrics) to the database server 106, which stores various information pertaining to the one or more customers. In an embodiment, the information pertaining to the one or more customers may include the historical data associated with the one or more customers such as, but not limited to, a customer's purchase transaction details, the customer's brand/product preferences and so on, in addition to the one or more second attributes associated with the customer. In response to the query, the one or more target customers may be determined. In an embodiment, the micro-processor 202 may receive the information pertaining to the one or more target customers from the database server 106. Alternatively, the one or more target customers may be flagged within the database server 106 for further processing, which may include creation of the targeted marketing campaigns.

For instance, to determine the one or more target customers from the one or more customers, the comparator 210 may check the one or more second attributes of each customer against the one or more overlay metrics. If the customer satisfies one or more criteria/ranges associated with the one or more overlay metric, i.e., at least one second attribute lies within the range of the corresponding overlay metric, the customer is selected as a target customer. In an embodiment, a customer is selected as a target customer when a relevancy score of the customer is above a pre-determined threshold. In an embodiment, the pre-determined threshold may be provided by an employee of the organization through the organization server 112. Alternatively, the pre-determined threshold may be determined heuristically. In an embodiment, the relevancy score may correspond to a ratio of a number of matching attributes to a total number of attributes within the one or more second attributes, where a second attribute is a matching attribute if the value of the second attribute for the customer lies within the range of values specified in the respective overlay metric. For example, the total number of attributes within the one or more second attributes is 8 and the pre-determined threshold is 0.70. If the number of matching attributes for a customer is 6, the relevancy score is 0.75, and hence the customer may be selected as a target customer for the marketing campaign.

Once a customer is checked against the one or more overlay metrics, the comparator 210 may check the next customers in the list by comparing the one or more second attributes of the next customer with the one or more overlay metrics, and so on, till the last customer. A person skilled in the art would appreciate that the scope of the disclosure is not limited to checking the entire list of the one or more customers to determine the one or more target customers. In embodiment, the traversal of the list of the one or more customers may end once a pre-determined number of target customers have been determined. In another embodiment, to determine the one or more target customers, the one or more customers may be clustered into one or more categories by utilizing one or more statistical techniques such as, but not limited to, k-means clustering, decision trees, Naïve Bayes algorithm, neural networks, or Support Vector Machine (SVM). Thereafter, the one or more target customers may be selected from a category of customers that meet or exceed the pre-determined threshold.

As discussed above, the one or more customers may include customers, who buy products/services of a competitor organization. Therefore, the one or more target customers may include customers who buy products/services of a competitor organization.

A person skilled in the art would appreciate that the database server 106 may be maintained by one or more second organizations such as, but not limited to, a retailer, a wholesaler, a distributor, a market researcher, a third-party organization, a government agency, a business unit of said organization. In an embodiment, the one or more second organizations may be associated with the organization through one or more contractual agreements. In an embodiment, the customer database (storing information pertaining to the one or customers) being maintained by above mentioned organizations is different from the social media platform database (storing information pertaining to the set of users registered on the one or more social media platforms).

At step 408, marketing campaigns are created for the one or more target customers of the organization. In an embodiment, the micro-processor 202 is configured to create the marketing campaigns for the one or more target customers. In an embodiment, the micro-processor 202 presumes that the identified target customers may be interested in the events in and around the location of the user. Therefore, the micro-processor 202 may identify products/services of the organization that may be of interest to target customers, and may usable by the target customers in the such events. For example, if the event corresponds to a morning walk club, and the organization is Nike, the micro-processor 202 may identify walking shoes from the portfolio of shoes offered by Nike as a relevant product for the marketing campaigns. Thereafter, the micro-processor 202 may create marketing campaigns for the walking shoes.

In another embodiment, the creation of the marketing campaigns may be based on the historical data associated with the one or more target customers, including the one or more second attributes. For instance, an organization such as IKEA™ that offers home furnishing products may be interested in events such as “Home Improvement Sales” (refer Table 2). Such an organization may create marketing campaigns for its target customers for such events based on the historical data (including purchase transaction details, brand/product preferences and one or more second attributes) of the target customers. Content of the marketing campaign may be customized on a per customer basis or on an aggregate customer level. For example, based on the purchase transaction details of the target customers, the organization may offer a discount/offer on the brands/products preferred by the target customer. The discount/offer may be commensurate to the target customer's previous transactions with the organization. For instance, a regular customer may be offered loyalty bonuses, credit points, and various free gifts/coupons that may be redeemable on a subsequent purchase from the organization. An infrequent customer on the other hand may be offered lower prices on regular products, combo deals/packages, and a cost-benefit analysis of purchasing regularly from the organization.

A person skilled in the art would appreciate that the scope of the disclosure should not be limited to the above examples, which are for the purpose of illustration only. Further, a person skilled in the art would appreciate that the marketing campaigns may be designed using one or more statistical techniques without departing from the scope of the disclosure. For example, the one or more target customers may be clustered into one or more groups based on the historical data. Thereafter, customized marketing campaigns may be designed for each group of target customers.

At step 410, the one or more media delivery channels for the marketing campaigns are determined based on the timeline associated with the one or more events. In an embodiment, the micro-processor 202 is configured to determine the one or more media delivery channels for the marketing campaigns. In an embodiment, the one or more media delivery channels may be determined based on the timeline associated with the one or more events. Examples of the one or more media delivery channels may include, but are not limited to, a direct-mailing channel, an email-messaging channel, a Short Messaging Service (SMS) channel, a print-media channel, a cell broadcasting channel, or a social media platform. For instance, faster media delivery channels (e.g., email-messaging, SMS, or direct posting on a social media platform) may be determined as suitable for events with a timeline in the immediate future such as within the forthcoming week (or even as soon as within a couple of days). The following table illustrates an example of the media delivery channels determined for various timelines:

TABLE 3
Example of media delivery channel determined
for various timelines of events

| Media Delivery Channel | Timeline associated with event |
|---|---|
| Direct-mailing | 2 days or later |
| Email-messaging | Immediate (few minutes) |
| SMS message | Immediate (few minutes) |
| Print-media | 4 days or later |
| Cell broadcasting channel | Immediate (few minutes) |
| Social media platform | Immediate (few minutes) |

As illustrated in the above table, the media delivery channels such as email-messaging, SMS, Cell broadcasting channel, and social media platforms are quicker means of bringing the marketing campaign to the one or more target customers. As shown in Table 3, such media delivery channels may have an almost immediate delivery timeline associated with them (i.e., within a few minutes). However, media delivery channels like direct-mailing and print-media may be slower with an associated timeline of 2 days or later and 4 days or later, respectively.

In another embodiment, the media delivery channel selected for delivering the marketing campaigns to the individual target customers may be dependent on one or more attributes associated with the target customers. For example, if the contact details associated with a target customer includes his/her email address, the marketing campaign may be delivered as an email message on the target customer's email address. However, if a mobile number of the target customer is available in the customer database, the marketing campaign may be delivered to the target customer through an SMS message or a Cell broadcast channel. Thus, the type of media delivery channel selected for delivering the marketing campaigns to a particular target customer may depend on the type of contact details of the target customer available in the customer database. A person skilled in the art would appreciate that more than one media delivery channels may be chosen for delivering the marketing campaigns to the target customers.

At step 412, the marketing campaigns are scheduled on the one or more media delivery channels, so determined. In an embodiment, the micro-processor 202 is configured to schedule the marketing campaigns on the one or more media delivery channels. In an embodiment, the scheduling may be based on the timeline of the event and the type of the event. Examples of the various types of events include, but are not limited to, a seasonal event, a personal event, a public event, a business event, or a sports event. For instance, a business event may be assigned a higher priority than a personal or seasonal event. Further, a public event may be assigned a higher priority than a sports events.

For example, the one or more events include three seasonal events S1, S2, and S3; two personal events P1 and P2; three public events U1, U2, and U3, a business event B1; and two sports events R1 and R2. The following table illustrates an example of priorities determined for these events:

TABLE 4
Example of priorities determined
for various events

| Event | Type | Timeline | Priority |
|---|---|---|---|
| S1 | Seasonal | 2 days | 1 |
| P1 | Personal | 3 days | 2 |
| U2 | Public | 3 days | 3 |
| R2 | Sports | 3 days | 4 |
| B1 | Business | 1 week | 5 |
| S2 | Seasonal | 1 week | 6 |
| U1 | Public | 1 week | 7 |
| P2 | Personal | 2 weeks | 8 |
| R1 | Sports | 2 weeks | 9 |
| S3 | Seasonal | 1 month | 10 |
| U3 | Public | 2 months | 11 |

As illustrated in the above table, the assigning of priorities to the various events may depend on the timeline of the event and the type of the event. The event S1 is assigned the highest priority as its timeline is the closest out of all the events, i.e., 2 days. The events next in-line based on the timeline are events P1, U2, and R2, each having a timeline of 3 days. As is evident from the table, the event P1 being a personal event is assigned a higher priority, followed by the event U2, a public event, and the event R2, a sports event. In an embodiment, the organization may determine such prioritization among events of various types based on the organization's business goals. For instance, in the above example, a personal event is given a higher priority considering an individual a better and higher priority target customer than the public at large. Similarly, as shown in Table 4, the events B1, S2, and U1, each having an associated timeline of 1 week, have been assigned priorities 5, 6, and 7, respectively. In this scenario, the event B1 is assigned a higher priority than the events S2 and U1 as the event B1 is a business event, which may have a higher return on marketing investment for the organization. A person skilled in the art would appreciate that various other methods or heuristics may be employed to prioritize events of different types that have a similar timeline.

At step 414, the marketing campaigns are sent to the one or more target customers on the one or more determined media delivery channels. In an embodiment, the micro-processor 202 sends the marketing campaigns to the one or more target customers on the one or more media delivery channels through the transceiver 206. In an embodiment, the marketing campaigns may be sent according to the schedule determined in step 412. In an embodiment, the one or more target customers may receive a notification corresponding to the marketing campaigns on a computing device, e.g., the user-computing device 110. For example, the one or more target customers may receive an email-message, an SMS message/cell broadcasting message (in case the user-computing device 110 is a mobile device such as a cell-phone), and/or a social media platform notification. Further, in the scenario where the marketing campaign is scheduled on media delivery channels like a direct-mailing channel or a print-media channel, the one or more target customers may receive content associated with the marketing campaign at a mailing address such as residential address or work address.

A person skilled in the art would appreciate the content of the marketing campaign may be modified and tuned based on the media delivery channel chosen for delivering the marketing campaign to the one or more target customers.

Further, in response to the receiving content associated with the marketing campaign, in an embodiment, the target customer may request for additional information associated with the marketing campaign. Based on the target customer's request, the target customer may be provided the additional information on either the communication channel through which the target customer made such request or the same media delivery channel on which the initial marketing campaign content was delivered.

In an embodiment, campaigning server 108 may deliver the marketing campaign to the one or more target customers through the one or more media delivery channels. In such a scenario, the campaigning server 108 may send content associated with the marketing campaign to the one or more target customers on the one or more media delivery channels based on the scheduling of the marketing campaign. Further, in an embodiment, the campaigning server 108 may monitor responses from the one or more target customers to the marketing campaign. Based on such responses, in an embodiment, the campaigning server 108 may modify content of the marketing campaign and re-launch a second round of the marketing campaign to a set of target customers from the one or more target customers, who responded to the marketing campaign. Further, the content of the marketing campaigns launched in the second round may be tuned for the set of target customers based on the historical data associated with such target customers.

FIG. 5 illustrates a flow diagram 500 for creating the marketing campaigns, in accordance with at least one embodiment. FIG. 5 has been explained in conjunction with FIG. 4.

As shown in FIG. 5, the one or more messages (depicted by 504) posted on the one or more social media platforms (depicted by 502) are analyzed to determine the one or more events (depicted by 506) associated with the organization. As shown in FIG. 5, the one or more events may include an event E1 of type T1, having an associated timeline of 2 days. The one or more events further include events E2, E3, E4, and E5 of types T2, T3, T2, and T1, respectively, having associated timelines of 1 week, 1 month, 3 days, and 2 weeks, respectively. The determination of the one or more events has been explained in step 402.

Thereafter, the one or more first attributes (depicted by 508) associated with the set of users of the social media platforms who posted messages related to the one or more events are determined. Various techniques known in the art may be used to first determine the users of interest (the set of users), i.e., the users who posted the messages, and thereafter mine the attributes of such users of interest, i.e., the one or more first attributes. The determination of the one or more first attributes has been explained in step 404.

Further, the one or more overlay metrics (depicted by 510) are derived from the one or more first attributes. In an embodiment, an overlay metric may correspond to a range of values of interest of a particular first attribute. The derivation of the one or more overlay metrics from the one or more first attributes has been explained in step 404.

Thereafter, the one or more overlay metrics (depicted by 510) are queried against the one or more second attributes (highlighted and depicted by 513) associated with the one or more customers of the organization. In an embodiment, the information pertaining to the one or more customers (depicted by 512) of the organization is stored on the database server 106. The information pertaining to each customer includes the one or more second attributes (highlighted and depicted by 513) and other data such as but not limited to, the customer's purchase transaction history, the customer's brand/product preferences, and so forth. For instance, as shown in FIG. 5, the one or more customers include the customers C1, C2, C3, . . . , Cn; and the one or more second attributes of the customers are A[C1], A[C2], A[C3], . . . , A[Cn], respectively.

Based on the overlaying of the one or more overlay metrics over the one or more second attributes, the one or more target customers of the organization are determined. The information pertaining to the one or more target customers has been depicted by 514. For instance, as shown in FIG. 5, the one or more target customers (highlighted and depicted by 515) include the target customers TC1, TC2, TC3, . . . , TCm, while the one or more second attributes of the target customers include A[TC1], . . . , A[TC2], A[TC3], . . . , A[TCm]. Further, the other data associated with the one or more target customers may include, but are not limited to, the target customer's purchase transaction history, the target customer's brand/product preferences, and so forth. The determination of the one or more target customers of the organization has been explained further in step 406.

Thereafter, the marketing campaigns (depicted by 516) are created for the one or more target customers (highlighted and depicted by 515). In an embodiment, the creation of the marketing campaigns (depicted by 516) may be based on the one or more second attributes (e.g., A[TC1], A[TC2], A[TC3], . . . , A[TCm]) of the one or more target customers (depicted by 515) and/or the historical data (e.g., the target customer's purchase transaction history, the target customer's brand/product preferences, and so forth) associated with the one or more target customers (depicted by 515). The creation of the marketing campaigns for the one or more target customers of the organization has been explained further in step 408.

Further, as explained in step 410, the one or more media delivery channels are determined for the marketing campaigns based on the timeline associated with the one or more events. As shown in FIG. 5, the one or more events (depicted by 506) include the events E1, E2, E3, E4, and E5 with the associated timelines of 2 days, 1 week, 1 month, 3 days, and 2 weeks, respectively. The events E2 (timeline of 1 week), E3 (timeline of 1 month), and E5 (timeline of 2 weeks) are events for which quicker media delivery channels may not be needed. Hence, the media delivery channels selected for the events E2, E3, and E5 may include print-media and/or direct-mailing (refer Table 3). However, for the events E1 and E4 with timelines of 2 days and 3 days respectively, a quicker media delivery channel such as an email-messaging channel, an SMS messaging channel, cell broadcasting channel, or a social media platform may be preferable.

Thereafter, as explained in step 412, the marketing campaigns may be scheduled on the one or more media delivery channels. As shown in FIG. 5, the timelines associated with the one or more events (depicted by 506) are 2 days, 1 week, 1 month, 3 days, and 2 weeks, respectively, for the events E1, E2, E3, E4, and E5. Thus, the schedule/priority determined for such events may be E1 (2 days), E4 (3 days), E2 (1 week), E5 (2 weeks), followed by E3 (1 month). The marketing campaigns may then be sent to the one or more target customers (depicted by 515) on the selected media delivery channel in accordance with the schedule, so determined (in accordance with step 414).

The disclosed embodiments encompass numerous advantages. The disclosure provides for determining target customers of an organization based on one or more overlay metrics. As discussed above, one or more messages posted on one or more social media platforms are analyzed to detect one or more events that may be relevant to the organization and may occur in or around an area of business of the organization. Thereafter, as discussed, one or more first attributes associated with the users of the social media platform, who posted the messages corresponding to the one or more events are determined. From the one or more first attributes, the one or more overlay metrics are derived. The one or more overlay metrics may be used to query a customer database by overlaying the one or more overlay metrics onto one or more second attributes related to one or more customers of the organization. Based on the comparison, one or more target customers of the organization are determined. Such target customers may correspond to previous customers of the organization who purchased products/services of the organization. The target customers may also correspond to the users of products/services of a competitor organization. As the attributes of target customers are similar to the attributes of the users of social media platform who are associated with the event, the target customers may also be interested in the event. Thus, marketing campaigns tailored for such events and directed towards such target customers may yield better results thereby realizing better return on marketing investment from such target customers through greater conversions.

Another advantage of the disclosure lies in the determination of media delivery channels according to the timelines associated with the various events. Further, the scheduling the marketing campaigns on the media delivery channels in accord with the capacity/lag of the media delivery channel and the timelines associated with the various events may help in reaching the target customers in at an appropriate time and better realize the marketing goals of the organization.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic.” Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for creating event-triggered marketing campaigns have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A system for creating event-triggered marketing campaigns, the system comprising:
a natural language processor configured to:
analyze one or more messages posted by one or more users on one or more social media platforms to extract information pertaining to one or more events, wherein said information comprises at least a location information and timeline information associated with said one or more events;
analyze user profile of a set of users, from one or more users, associated with said one or more events, to determine one or more first attributes associated with said set of users;
one or more micro-processors configured to:
determine one or more target customers from one or more customers associated with an organization, based on a comparison of said one or more first attributes and one or more second attributes associated with said one or more customers;
create said marketing campaigns for said one or more target customers based at least on said one or more second attributes and a historical data associated with said one or more target customers, wherein one or more media delivery channels for said marketing campaigns are determined based on said timeline associated with each of said one or more events; and
a transceiver configured to:
send said marketing campaigns to said one or more target customers on said one or more media delivery channels.

2. The system of claim 1, wherein said one or more micro-processors are further configured to schedule said marketing campaigns, for said one or more target customers, on said one or more media delivery channels.

3. The system of claim 2, wherein said one or more media delivery channels correspond to at least one of a direct-mailing channel, an email-messaging channel, a Short Messaging Service (SMS) channel, a print-media channel, a cell broadcasting channel, or said one or more social media platforms.

4. The system of claim 1, wherein said location associated with said one or more events correspond to an area of business of said organization.

5. The system of claim 1, wherein said one or more social media platforms correspond to at least one of a social networking website, a chat/messaging application, a web-blog, web-forums, a community portal, an online community, or an online interest group.

6. The system of claim 1, wherein said one or more events correspond to at least one of a seasonal event, a personal event, a public event, a business event, or a sports event.

7. The system of claim 1, wherein each of said one or more first attributes and each of said one or more second attributes correspond to at least one of an age, a gender, an educational qualification, an occupation, an income level, a marital status, a location of residence/work, or hobbies/interests.

8. The system of claim 1 further comprising a comparator configured to compare said one or more first attributes and said one or more second attributes of said one or more customers.

9. The system of claim 1, wherein said one or more micro-processors are further configured to determine one or more overlay metrics from said one or more first attributes, wherein said one or more overlay metrics are compared with said one or more second attributes to determine said one or more target customers.

10. A method for creating event-triggered marketing campaigns, the method comprising:
determining, by a natural language processor, one or more events based on an analysis of one or more messages posted by one or more users on one or more social media platforms, wherein each of said one or more events has an associated location and an associated timeline;
determining, by said natural language processor, one or more first attributes, associated with a set of users, from said one or more users, corresponding to each of said one or more events;
determining, by one or more micro-processors, one or more target customers from one or more customers associated with an organization, based on a comparison of said one or more first attributes and one or more second attributes associated with said one or more customers;
creating, by said one or more micro-processors, said marketing campaigns for said one or more target customers based at least on said one or more second attributes and a historical data associated with said one or more target customers, wherein one or more media delivery channels for said marketing campaigns are determined based on said timeline associated with each of said one or more events; and
sending, by a transceiver, said marketing campaigns to said one or more target customers on said one or more media delivery channels.

11. The method of claim 10 further comprising scheduling, by said one or more micro-processors, said marketing campaigns, for said one or more target customers, on said one or more media delivery channels.

12. The method of claim 11, wherein said one or more media delivery channels correspond to at least one of a direct-mailing channel, an email-messaging channel, a Short Messaging Service (SMS) channel, a print-media channel, a cell broadcasting channel, or said one or more social media platforms.

13. The method of claim 10, wherein said location associated with said one or more events correspond to an area of business of said organization.

14. The method of claim 10, wherein said one or more social media platforms correspond to at least one of a social networking website, a chat/messaging application, a web-blog, web-forums, a community portal, an online community, or an online interest group.

15. The method of claim 10, wherein said one or more events correspond to at least one of a seasonal event, a personal event, a public event, a business event, or a sports event.

16. The method of claim 10, wherein each of said one or more first attributes and each of said one or more second attributes correspond to at least one of an age, a gender, an educational qualification, an occupation, an income level, a marital status, a location of residence/work, or hobbies/interests.

17. The method of claim 10 further comprising determining, said one or more micro-processors, one or more overlay metrics from said one or more first attributes, wherein said one or more overlay metrics are compared with said one or more second attributes to determine said one or more target customers.

18. A computer program product for use with a computer, the computer program product comprising a non-transitory computer readable medium, wherein the non-transitory computer readable medium stores a computer program code for creating event-triggered marketing campaigns, wherein the computer program code is executable by one or more micro-processors to:
determine, by a natural language processor, one or more events based on an analysis of one or more messages posted by one or more users on one or more social media platforms, wherein each of said one or more events has an associated location and an associated timeline;
determine, by said natural language processor, one or more first attributes, associated with a set of users, from said one or more users, corresponding to each of said one or more events;
determine, by one or more micro-processors, one or more target customers from one or more customers associated with an organization, based on a comparison of said one or more first attributes and one or more second attributes associated with said one or more customers;
create, by said one or more micro-processors, said marketing campaigns for said one or more target customers based at least on said one or more second attributes and a historical data associated with said one or more target customers, wherein one or more media delivery channels for said marketing campaigns are determined based on said timeline associated with each of said one or more events; and
send, by a transceiver, said marketing campaigns to said one or more target customers on said one or more media delivery channels.

19. The computer program product of claim 18, wherein said computer program code is further executable by said one or more micro-processors to schedule said marketing campaigns, for said one or more target customers, on said one or more media delivery channels.

20. The computer program product of claim 19, wherein said one or more media delivery channels correspond to at least one of a direct-mailing channel, an email-messaging channel, a Short Messaging Service (SMS) channel, a print-media channel, a cell broadcasting channel, or said one or more social media platforms.

21. The computer program product of claim 18, wherein said location associated with said one or more events correspond to an area of business of said organization.

22. The computer program product of claim 18, wherein said one or more events correspond to at least one of a seasonal event, a personal event, a public event, a business event, or a sports event.

23. The computer program product of claim 18, wherein each of said one or more first attributes and each of said one or more second attributes correspond to at least one of an age, a gender, an educational qualification, an occupation, an income level, a marital status, a location of residence/work, or hobbies/interests.

24. The computer program product of claim 18, wherein said computer program code is further executable by said one or more micro-processors to determine one or more overlay metrics from said one or more first attributes, wherein said one or more overlay metrics are compared with said one or more second attributes to determine said one or more target customers.
